(19) United States
(12) Patent Application Publication
(10) Pub. No.: US 2019/0197433 A1
(43) Pub. Date: Jun. 27, 2019

(54) METHODS FOR ADAPTIVE INFORMATION EXTRACTION THROUGH ADAPTIVE LEARNING OF HUMAN ANNOTATORS AND DEVICES THEREOF

(71) Applicant: Wipro Limited, Bangalore (IN)

(72) Inventor: Samrat Saha, Bangalore (IN)

(21) Appl. No.: 15/888,800

(22) Filed: Feb. 5, 2018

(30) Foreign Application Priority Data
Dec. 22, 2017 (IN) 201741046340

(51) Int. Cl. G06N 99/00; G06N 5/02

(52) U.S. Cl. CPC G06N 99/005; G06N 5/025

(57) ABSTRACT

Methods, non-transitory computer readable media, and information extraction computing devices that apply one or more named entity (NE) or relationship extraction (RE) classifier models to an obtained semi-structured or unstructured machine-readable input data corpus to extract and output structured data to an interactive graphical user interface (GUI). An annotation of at least one RE missed classification, RE misclassification, or NE misclassification in the structured data is obtained via the interactive GUI. A determination is made when the RE missed classification or RE misclassification resulted from the NE misclassification or an NE missed classification based on an analysis of the annotation and one or more merged relationship classes or relation triplet objects. The NE classifier model is retuned based on the NE missed classification or NE misclassification, when the determining indicates that the RE missed classification or RE misclassification resulted from the NE misclassification or NE missed classification.

This application claims the benefit of Indian Patent Application Serial No. 201741046340, filed Dec. 22, 2017, which is hereby incorporated by reference in its entirety.

### FIELD

This technology generally relates to methods and devices for natural language processing (NLP) and, more particularly, to improved information extraction through adaptive learning or also referred to as online learning with the help of statistical classifiers, deterministic classifiers, and human annotators.

### BACKGROUND

Natural language processing (NLP) is a field of artificial intelligence concerned with the interactions between machines and natural languages used by humans. In one aspect, NLP involves interpreting natural language data sources in various structures and formats. The capability of machines to interpret natural language data, and avoid issues with respect to text alignment, sentence identification, and data corruption, for example, is based at least in part on the source data formatting. Poorly formatted source data and/or inaccuracies with respect to the NLP can result in the interpretation of improper sentences, corrupted words, and/or data having limited meaning or value.

In addition to interpreting natural language data, in another aspect, NLP can involve extracting structured meaningful data from unstructured or semi-structured data, which can be in a machine-readable format (e.g., HTML, PDF, image data converted through Optical Character Recognition (OCR) and text extraction). In order to process large amounts of unstructured or semi-structured dark or unseen data to extract meaningful structured data, tasks including named entity recognition and relationship extraction can be performed. Named entity recognition generally involves identifying and classifying named entities (e.g., custom named entities specific to a business domain) in text into pre-defined categories. Relationship extraction generally requires recognizing semantic relations between named entities in unstructured text.

Current methods of carrying out such information extraction (IE) tasks result in reduced accuracy in unseen live unstructured data with respect to resulting structured data. The reduced accuracy is due, at least in part, to an inability to identify named entity classifications that were missed during the named entity classification task performed on the input data. Moreover, current NLP systems are unable to learn and improve accuracy sequentially when deployed in live environments without human feedback or some other feedback mechanism. Accordingly, current NLP systems exhibit relatively low precision and recall for IE tasks when handling unseen data, which negatively impacts the accuracy of extraction where highly precise information is required to be extracted from unseen data.

### SUMMARY

A method for improved information extraction (IE) using adaptive learning and statistical and deterministic classifiers includes applying one or more named entity (NE) or relationship extraction (RE) classifier models to an obtained semi-structured or unstructured machine-readable input data corpus to extract and output structured data to an interactive graphical user interface (GUI). An annotation of at least one RE missed classification, RE misclassification, or NE misclassification in the structured output data is obtained via the interactive GUI. A determination is made when the RE missed classification or RE miss classification resulted from an NE missed classification, NE miss classification based on an analysis of the annotation and one or more merged relationship classes or relation triplet objects. The NE models are retuned based on the NE misclassification or NE missed classification, when the determining indicates that the RE missed classification or RE misclassification resulted from the NE misclassification or NE missed classification.

An IE computing device, comprising memory comprising programmed instructions stored thereon and one or more processors configured to be capable of executing the stored programmed instructions to apply one or more NE or RE classifier models to an obtained semi-structured or unstructured machine-readable input data corpus to extract and output structured data to an interactive GUI. An annotation of at least one RE missed classification, RE misclassification, or NE misclassification in the structured data is obtained via the interactive GUI. A determination is made when the RE missed classification or RE misclassification resulted from the NE misclassification or an NE missed classification based on an analysis of the annotation and one or more merged relationship classes or relation triplet objects. The NE classifier model is retuned based on the NE missed classification or NE misclassification, when the determining indicates that the RE missed classification or RE misclassification resulted from the NE misclassification or NE missed classification.

A non-transitory computer readable medium having stored thereon instructions for improved IE using adaptive learning and statistical and deterministic classifiers comprising executable code which when executed by one or more processors, causes the one or more processors to apply one or more NE or RE classifier models to an obtained semi-structured or unstructured machine-readable input data corpus to extract and output structured data to an interactive GUI. An annotation of at least one RE missed classification, RE misclassification, or NE misclassification in the structured data is obtained via the interactive GUI. A determination is made when the RE missed classification or RE misclassification resulted from the NE misclassification or an NE missed classification based on an analysis of the annotation and one or more merged relationship classes or relation triplet objects. The NE classifier model is retuned based on the NE missed classification or NE misclassification, when the determining indicates that the RE missed classification or RE misclassification resulted from the NE misclassification or NE missed classification.

This methods, non-transitory computer readable media, and IE computing devices of this technology provide a number of advantages including improved accuracy of IE for unseen and unstructured or semi-structured textual data. In particular, this technology is dynamic and advantageously utilizes feedback regarding misclassifications and missed classifications to calibrate and adapt or retune classifiers. With this technology, feedback is interpreted based on a machine-readable annotation language to facilitate automated determination of NE missed classifications in an input data corpus and retuning of the classifiers in associated classification models in order to improve the functioning of NLP natural language processing (NLP) systems and automatically learn and improve IE over time.

### BRIEF DESCRIPTION OF THE DRAWINGS

FIG. 1 is a block diagram of a network environment with an exemplary information extraction (IE) computing device;

FIG. 2 is a block diagram of the exemplary IE computing device of FIG. 1;

FIG. 3 is a flow chart of an exemplary method for facilitating improved IE using adaptive and deterministic classifiers;

### DETAILED DESCRIPTION

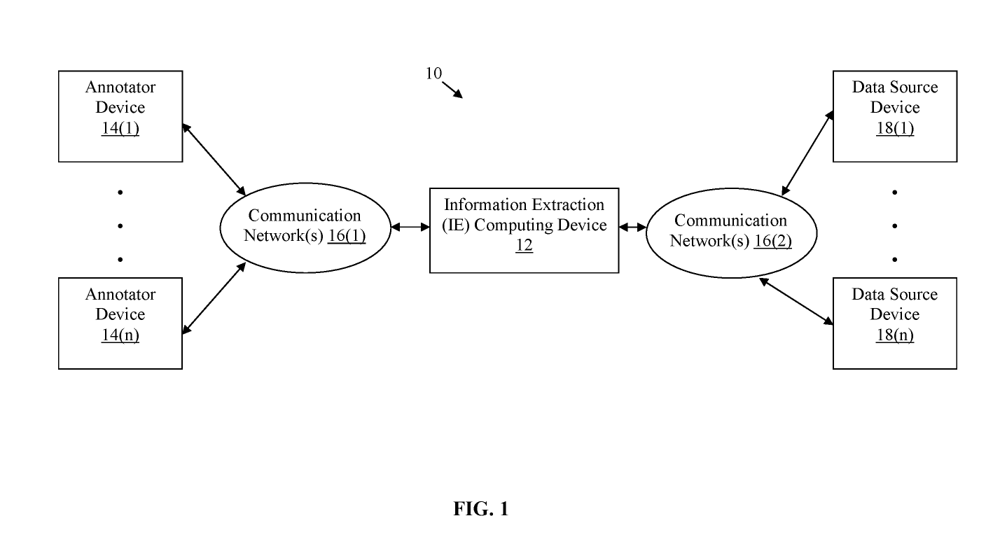

Referring to FIG. 1, an exemplary network environment 10 with an exemplary information extraction (IE) computing device 12 is illustrated. The IE computing device 12 in this example is coupled to annotator devices 14(1)-14(n) via communication network(s) 16(1) and data source devices 18(1)-18(n) via communication networks 16(2), although the IE computing device 12, annotator devices 14(1)-14(n), and data source devices 18(1)-18(n), may be coupled together via other topologies. Additionally, the network environment 10 may include other network devices such as routers or switches, for example, which are well known in the art and thus will not be described herein. This technology provides a number of advantages including methods, non-transitory computer readable media, and IE computing devices that improve the accuracy of automated IE for unseen and unstructured or semi-structured textual data via supervised learning and automated detection of missed named entity classifications.

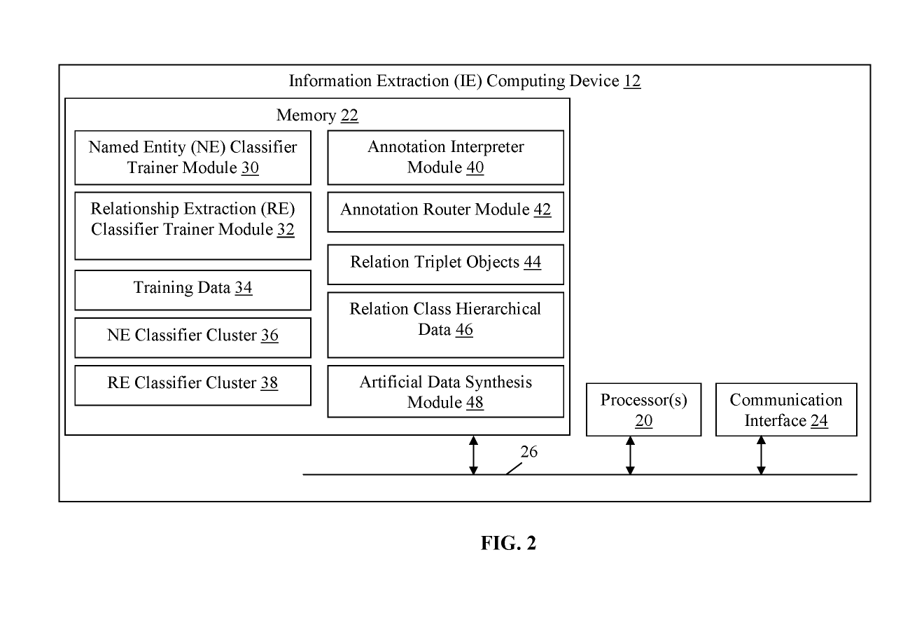

Referring to FIGS. 1-2, the IE computing device 12 generally analyzes input dat corpora obtained from the data source devices 18(1)-18(n) to execute a pipeline of natural language processing (NLP) operations resulting in the extraction of information provided as output data corpora. The IE computing device 12 in this example includes processor(s) 20, a memory 22, and/or a communication interface 24, which are coupled together by a bus 26 or other communication link, although the IE computing device 12 can include other types and/or numbers of elements in other configurations.

The processor(s) 20 of the IE computing device 12 may execute programmed instructions stored in the memory 22 for the any number of the functions identified earlier and described and illustrated in more detail later. The processor(s) 20 may include one or more CPUs or general purpose processors with one or more processing cores, for example, although other types of processor(s) can also be used in other examples.

The memory 22 of the IE computing device 12 stores these programmed instructions for one or more aspects of the present technology as described and illustrated herein, although some or all of the programmed instructions could be stored elsewhere. A variety of different types of memory storage devices, such as random access memory (RAM), read only memory (ROM), hard disk, solid state drives, flash memory, or other computer readable medium which is read from and written to by a magnetic, optical, or other reading and writing system that is coupled to the processor(s) 20, can be used for the memory 22.

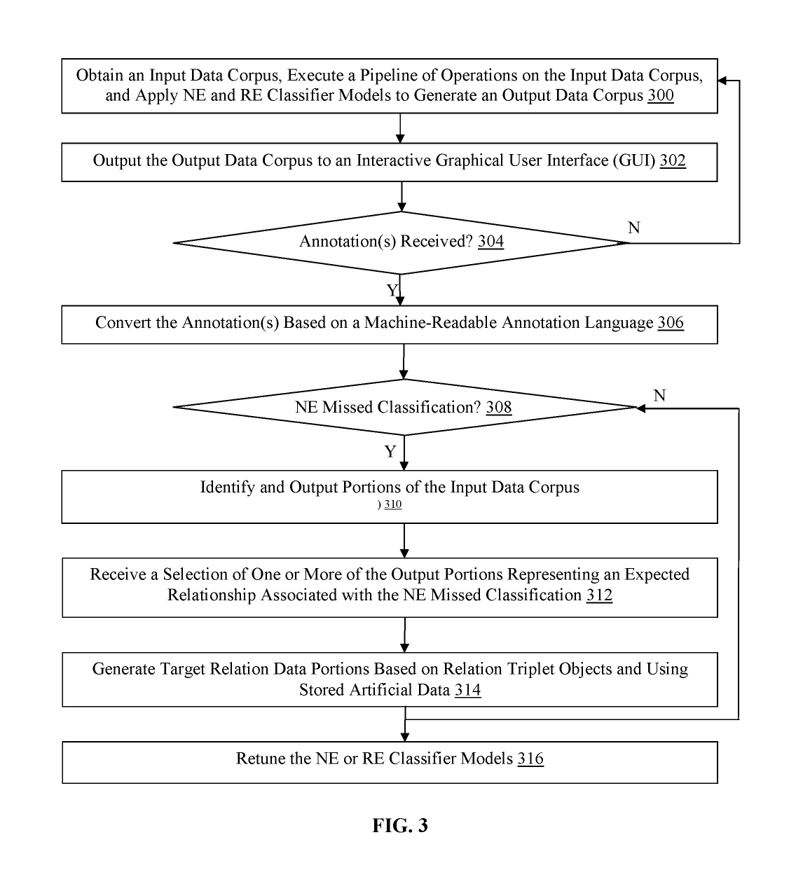

Accordingly, the memory 22 of the IE computing device 12 can store application(s) that can include computer or machine executable instructions that, when executed by the IE computing device 12, cause the IE computing device 12 to perform actions, such as to transmit, receive, or otherwise process messages and data, for example, and to perform other actions described and illustrated below with reference to FIG. 3. The application(s) can be implemented as modules or components of other applications. Further, the application(s) can be implemented as operating system extensions, module, plugins, or the like.

Even further, the application(s) may be operative in a cloud-based computing environment. The application(s) can be executed within or as virtual machine(s) or virtual server(s) that may be managed in a cloud-based computing environment. Also, the application(s), and even the IE computing device 12 itself, may be located in virtual server(s) running in a cloud-based computing environment rather than being tied to one or more specific physical network computing devices. Also, the application(s) may be running in one or more virtual machines (VMs) executing on the IE computing device 12. Additionally, in embodiment(s) of this technology, virtual machine(s) running on the IE computing device 12 may be managed or supervised by a hypervisor.

In this particular example, the memory 22 includes a named entity (NE) classifier trainer module 30, a relationship extraction (RE) classifier trainer module 32, training data 34, an NE classifier cluster 36, an RE classifier cluster 38, an annotation interpreter module 40, an annotation router module 42, relation triplet objects 44, relation class hierarchical data 46, and an artificial data synthesis module 48, although the memory 22 can include other policies, modules, databases, or applications, for example. The NE classifier trainer module 30 in this example facilitates generation of an NE classifier model based on the NE classifier cluster 36 and using the training data 34. The training data can includes any unstructured or semi-structured text-based machine-readable data corpora (e.g., HTML or PDF).

The NE classifier trainer module 30 includes an NE conditional random field (CRF) trainer, an NE regular expression trainer, and an NE cascaded annotation trainer that are used to train classifiers of the NE classifier cluster and generate the NE classifier model, although other types of trainers can also be used in other examples. The NE classifier cluster 36 in one particular example can include a plurality of classifiers such as a CRF named entity recognition (NER) classifiers ordeterministic classifiers, although other classifiers can also be used in other examples.

The RE classifier trainer module 32 facilitates generation of an RE classifier model based on the RE classifier cluster 38 and using the training data 34. The RE classifier trainer module 32 trains probabilistic and deterministic classifiers of the RE classifier cluster 38, automatically and using tagged training data 34 until optimality is reached, and generate the RE classifier model, although other types of trainers can also be used in other examples. The RE classifier cluster 36 in one particular example can include a plurality of classifiers such as a CRF relation classifier or a cascaded token-based deterministic classifier, for example, although other classifiers can also be used.

The annotation interpreter module 40 in this example is configured to interpret annotations received from the annotator devices 14(1)-14(n) and convert the annotations into a machine-readable format. The annotations in the machine-readable format are routed to the annotation router module 42, which routes the interpreted annotations to either the NE classifier trainer module 30 or the RE classifier trainer module 32. The annotation router module 42 is also configured to automatically determine whether an NE missed classification, also referred to herein as “NE_MISSEDCLASSIFICATION,” has occurred, which cannot be recognized by an annotator.

The annotation router module 42 utilizes the relation triplet objects 44 and the relation class hierarchical data 46 to determine whether an NE classification has been missed. The relation triplet objects 44 store relationships between entities represented as subjects, predicates, and/or objects. For example, “ORGANIZATION,” “TRADED_EXCHANGE,” AND “STOCK_EXCHANGE” can be a relation triplet (e.g., “Wipro,” “TRADED_EXCHANGE,” and “NYSE,” respectively). The hierarchical data 46 stores hierarchical associations of parent and child relation classes. For example, a “TRADED_AS” parent relation class may have two children: “TRADED_EXCHANGE” and “TRADED_NAME” (e.g., “NYSE” and “WIT,” respectively).

The annotation router 42 is further configured to generate possible correct data portions, also referred to herein as sentences, of an input data corpus in which a target relationship can be found in order to output the data portions to an interactive GUI and utilize a response from one of the annotator devices 14(1)-14(n) to further train or retune the NE or RE classifier model(s). The operation of the annotation router module 42 is described and illustrated in more detail below with reference to FIG. 3.

The artificial data synthesis module 48 in this example is configured to generate artificial training data for annotated correct data portions that can be output to an interactive GUI and utilize a response from one of the annotator devices 14(1)-14(n) to further train or retune the NE or RE classifier model(s), as described and illustrated in more detail below with reference to FIG. 3, for example. Accordingly, the response obtained via the interactive GUI from annotator device(s) 14(1)-14(n) with respect to possible correct data portions and/or artificial data portions can be used to retune the NE or RE classifier model(s) depending on the configuration of the IE computing device 12.

The communication interface 24 of the IE computing device 12 operatively couples and communicates between the IE computing device 12 and at least the annotator devices 14(1)-14(n) and data source devices 18(1)-18(n), which are all coupled together by the communication network(s) 16(1) and 16(2), although other types and/or numbers of communication networks or systems with other types and/or numbers of connections and/or configurations to other devices and/or elements can also be used.

By way of example only, the communication network(s) 16(1) and 16(2) can include local area network(s) (LAN(s)) or wide area network(s) (WAN(s)), and can use TCP/IP over Ethernet and industry-standard protocols, although other types and/or numbers of protocols and/or communication networks can be used. The communication network(s) 16(1) and 16(2) in this example can employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

While the IE computing device 12 is illustrated in FIG. 1 as a standalone device, in other examples, the IE computing device 12 can be part of one or more of the annotator devices 14(1)-14(n) or data source devices 18(1)-18(n), such as a module of one or more of the annotator devices 14(1)-14(n) or data source devices 18(1)-18(n) or a device within one or more of the annotator devices 14(1)-14(n) or data source devices 18(1)-18(n). In yet other examples, one or more of the annotator devices 14(1)-14(n), data source devices 18(1)-18(n), or IE computing device 12 can be part of the same apparatus, and other arrangements of the devices of FIG. 1 can also be used.

Each of the annotator devices 14(1)-14(n) in this example is any type of computing device that can receive, render, and facilitate user interaction with graphical user interfaces, such as mobile computing devices, desktop computing devices, laptop computing devices, tablet computing devices, or the like. Each of the annotator devices 14(1)-14(n) in this example includes a processor, a memory, and a communication interface, which are coupled together by a bus or other communication link, although other numbers and/or types of network devices could be used.

Each of the annotator devices 14(1)-14(n) may further include a display device, such as a display screen or touchscreen, and/or an input device, such as a keyboard, for example. The annotator devices 14(1)-14(n) may run interface applications, such as standard web browsers or standalone client applications, which may provide an interface to communicate with the IE computing device 12 via the communication network(s) 18(1) and a provided interactive GUI.

Each of the data source devices 18(1)-18(n) in this example includes one or more processors, a memory, and a communication interface, which are coupled together by a bus or other communication link, although other numbers and/or types of network devices could be used. The data source devices 18(1)-18(n) host input data corpora in unstructured or semi-structured machine-readable formats, such as text-based HTML or PDF electronic documents, which can be retrieved and analyzed by the IE computing device 12, as described and illustrated in detail herein.

The data source devices 18(1)-18(n) may be hardware or software or may represent a system with multiple servers in a pool, which may include internal or external networks. The data source devices 18(1)-18(n) may operate as a plurality of network computing devices within a cluster architecture, a peer-to peer architecture, virtual machines, or within a cloud architecture, for example. The technology disclosed herein is not to be construed as being limited to a single environment and other configurations and architectures are also envisaged.

Although the exemplary network environment 10 with the IE computing device 12, annotator devices 14(1)-14(n), data source devices 18(1)-18(n), and communication network(s) 16(1) and 16(2) are described and illustrated herein, other types and/or numbers of systems, devices, components, and/or elements in other topologies can be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 10, such as the IE computing device 12, annotator devices 14(1)-14(n), or data source devices 18(1)-18(n), for example, may be configured to operate as virtual instances on the same physical machine. In other words, one or more of the IE computing device 12, annotator devices 14(1)-14(n), data source devices 18(1)-18(n) may operate on the same physical device rather than as separate devices communicating through communication network(s) 26. Additionally, there may be more or fewer IE computing device 12, annotator devices 14(1)-14(n), data source devices 18(1)-18(n) than illustrated in FIG. 1.

In addition, two or more computing systems or devices can be substituted for any one of the systems or devices in any example. Accordingly, principles and advantages of distributed processing, such as redundancy and replication also can be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

An exemplary method of improved IE will now be described with reference to FIGS. 1-3. Referring more specifically to FIG. 3, a flow chart of an exemplary method for facilitating improved IE using adaptive and deterministic classifiers is illustrated. In step 300 in this example, the IE computing device 12 obtains an input data corpus, executes a pipeline of operations on the input data corpus, and applies NE and RE classifier models to generate structured data. The input data corpus can be unstructured or semi-structured textual data in a machine-readable format that is obtained from one or more of the data source devices 18(1)-18(n), for example. The input data corpus can be an HTML web page document or a PDF electronic document, for example, although other types of input data corpora can also be used.

In this example, the pipeline of operations includes various NLP operations such as tokenizing, splitting, part-of-speech tagging, lemmatizing, or parsing. The NE and RE classifier models can be generated as described and illustrated earlier, and the operations executed on the input data corpus can include applying one or more deterministic or CRF statistical classifiers of the NE or RE models, such as may be included in the NE classifier cluster 36 or RE classifier cluster 38, for example, in order to extract meaningful information from the input data corpus. The IE computing device 12 then generates structured data based on the extracted meaningful information. In this example, the IE computing device 12 provides the structured data to a user of one of the annotator devices 14(1)-14(n) in a structured format for review via an interactive GUI.

In step 304, the IE computing device 12 determines whether any annotations are received, via the interactive GUI, from a user of the one of the annotator devices 14(1)-14(n). The annotations in this example can be RE missed classifications, RE misclassifications, or NE misclassifications in the structured data and can include an expected result input by the user of the one of the annotator devices 14(1)-14(n) for a particular relationship or entity. If the IE computing device 12 determines that an annotation has not been received via the interactive GUI, then the No branch is taken back to step 300 and the method illustrated in FIG. 3 is optionally repeated for another input data corpus.

However, if the IE computing device 12 determines that annotation(s) have been received via the interactive GUI, then the Yes branch is taken to step 306. In step 306, the IE computing device 12 converts the received annotation(s) based on a machine-readable annotation language. The machine-readable annotation language can have a particular format such as “{Error type, Subject, Extracted, Expected},” although other types of machine-readable annotation language and other formats can also be used in other examples.

In one particular example, the input data corpus can be an annual report for a corporate organization (i.e., “Wipro Ltd.”) and the structured data includes desired relationships for specific entities in the business domain. In Example 1 illustrated below in Table 1, the structured data indicates that “Abidali Z” has a relation of “CTO” with respect to the entity “WIPRO”:

TABLE 1
Example 1: NE_MISCLASSIFICATION

| Entity Name | Desired Relation | Extracted |
|---|---|---|
| WIPRO | CTO | Abidali Z |

In this example a user of one of the annotator devices 14(1)-14(n) submits an annotation via the provided interactive GUI to indicate that the information extracted should have identified “Abidali Z. Neemuchwala” instead of “Abidali Z” for the “CTO” relation for the “WIPRO” entity, and that there was an NE misclassification with respect to that particular person. Accordingly, the IE computing device 12 converts the annotation corresponding to the NE misclassification, as received from the user of the one of the annotator devices 14(1)-14(n), into the machine-readable annotation language “{NE_MISCLASSIFICATION, WIPRO, PERSON, Abidali Z, Abidali Z. Neemuchwala}.”

Referring to Example 2 illustrated below in Table 2, the structured data indicates that “BSE: 507685” and “NSE: WIPRO” have a “TRADED_AS” relation with the “WIPRO” entity:

TABLE 2
Example 2: RE_MISSEDCLASSIFICATION
& RE_MISSCLASSIFICATION

| Entity Name | Desired Relation | Extracted |
|---|---|---|
| WIPRO | TRADED_AS | BSE: 507685 |
| WIPRO | CTO | NSE: WIPRO |

However, a user of one of the annotator devices 14(1)-14(n) submits an annotation via the provided interactive GUI indicating an expected data output of “NYSE:WIT” In other words, the “WIPRO” entity is also traded as “WIT” on the “NYSE,” but the IE computing device 12 failed to extract this information from the input data corpus, and therefore there were several RE missed classifications. Accordingly, the IE computing device 12 converts the annotation corresponding the RE missed classifications, as received from the user of the one of the annotator devices 14(1)-14(n), into the machine-readable annotation language “{RE_MISSEDCLASSIFICATION), WIPRO, TRADED_AS, BSE:507685, NYSE:WIT} {RE_MISSEDCLASSIFICATION), WIPRO, TRADED_AS, NSE:WIPRO,NYSE:WIT} {RE_MISSEDCLASSIFICATION), WIPRO, TRADED_AS, NONE, NYSE:WIT}.”

The below Example 3 in Table 3 represents an RE misclassification, an RE missed classification, and an NE misclassification:

TABLE 3
Example 3: RE_MISSEDCLASSIFICATION &
RE_MISSCLASSIFICATION & NE_MISSCLASSIFICATION

| Entity Name | Desired Relation | Extracted |
|---|---|---|
| WIPRO | BOARD_OF_DIR | Rishad Premji |
| WIPRO | BOARD_OF_DIR | Abidali Neemuchwala |
| WIPRO | BOARD_OF_DIR | M. K. Sharma |

In this example, a user of one of the annotator devices 14(1)-14(n) submits an annotation via the provided interactive GUI indicating that the information extracted should have identified “Abidali Z. Neemuchwala” instead of “Abidali Neemuchwala,” for the “BOARD_OF_DIR” relation for the “WIPRO” entity, and that there was therefore an NE misclassification.

Additionally, a user of one of the annotator devices 14(1)-14(n) submits another annotation via the provided interactive GUI indicating that for the “WIPRO” entity, “M. K. Sharma” is not of the “BOARD_OF_DIR” relation and that “Rishad Premji” should have been identified as of the “BOARD_OF_DIR” relation for the “WIPRO” entity. In other words, “M. K. Sharma” is not a member of the board of directors of the “WIPRO” entity, and has been misclassified as such, and “Rishad Premji” has not, but should have, been identified as a member of the board of directors of the “WIPRO” entity. Accordingly, the IE computing device 12 converts the annotations identifying the NE and RE misclassifications, as received from the user of the one of the annotator devices 14(1)-14(n), into the machine-readable annotation language “{NE_MISCLASSIFICATION), WIPRO, BOARD_OF_DIR, Abidali Neemuchwala, Abidali Z. Neemuchwala} {RE_MISCLASSIFICATION), WIPRO, BOARD_OF_DIR, M. K. Sharma , Rishad Premji}.”

In step 308, the IE computing device 12 determines whether any of the RE missed classification(s), RE misclassification(s), or NE misclassification(s) associated with the annotation(s) received in step 304 resulted from an NE missed classification. The determination in step 304 is based on an analysis of the annotation(s) and one or more merged relationship classes, identified from the relation class hierarchical data 46. An NE missed classification occurs when a recognized named entity failed to be identified as corresponding to a particular class. Human annotators are incapable of determining whether an NE missed classification has occurred.

In order to determine whether an NE missed classification occurred, the IE computing device 12 compares the relation for one of the annotation(s) in the machine-readable annotation language to the relation class hierarchical data 46 to identify any matches and any associated child class relations. If a match is identified having child class relations, the relation class in the annotation can be considered a merged relationship class.

Referring back to Example 2 in Table 2, the relation class in the machine-readable annotation language 402 is “TRADED_AS.” In this example, a comparison of “TRADED_AS” in the relation class hierarchical data 46 indicates that “TRADED_AS” is a parent relation class having two child relation classes: “TRADED_EXCHANGE” and “TRADED_NAME.” Accordingly, “TRADED_AS” is a merged relationship class. In the machine-readable annotation language 402, the expected result is “NYSE:WIT.” In order for the IE computing device 12 to extract “NYSE:WIT” for the “TRADED_AS” relation class, the “TRADED_EXCHANGE” and “TRADED_NAME” relation classes should extract as indicated in the below Table 4 for the “WIPRO” entity name:

TABLE 4

| SUBJECT | PREDICATE | OBJECT |
|---|---|---|
| WIPRO | TRADED_EXCHANGE | NYSE |
| WIPRO | TRADED_NAME | WIT |

If the IE computing device 12 determines that the relation class in the annotation is not a merged relationship class, then the IE computing device 12 determines that there was not an NE missed classification and the No branch is taken from step 308. However, if the IE computing device 12 determines that the relation class in the annotation is a merged relationship class, then IE computing device 12 compares the child relation classes to the relation triplet objects 44 to identify one or more relation triplets for the child relation classes. In this example, “TRADED_EXCHANGE” is a relation triplet between “ORGANIZATION” and “STOCK_EXCHANGE” and “TRADED_NAME” is a relation triplet between “ORGANIZATION” and “SCRIP_NAME.”

In order to determine whether the identified relationship triplets have a named entity relationship with the expected result objects in the annotation, the IE computing device 12 can re-execute the pipeline of operations, previously executed in step 300, on the input data corpus up to applying the NE classifier model (e.g., classifiers of the NE classifier cluster 36). Accordingly, the IE computing device 12 executes the pipeline of operations on the input data corpus, with the exception of the application of the NE classifier model, and generates a subsequent structured data.

The IE computing device 12 then searches the subsequent structured data for each of the expected result objects in the annotation to determine whether there is a named entity relationship. If the IE computing device 12 determines that there is a named entity relationship between the expected result object(s) and the identified relation triplet(s), then there is at least one NE missed classification. In this example, if there is at least one NE missed classification, then the IE computing device 12 generates machine-readable annotation language corresponding to the NE missed classification(s). However, if the IE computing device 12 determines that there is not a named entity relationship between any of the expected result object(s) and the identified relation triplet(s), then the IE computing device 12 determines that there was not an NE missed classification and the No branch is taken from step 308.

In the example described and illustrated herein, the IE computing device 12 searches the subsequent structured data for the “NYSE” and “WIT” expected result objects and determines that “NYSE” has a named entity relationship with the “STOCK_EXCHANGE” relation triplet and “WIT” has a named entity relationship with the “SCRIP_NAME” relation triplet. Accordingly, the IE computing device 12 generates the following machine-readable annotation language corresponding to the two NE missed classifications that resulted in the RE missed classification of Example 2 illustrated earlier: “{NE_MISSEDCLASSIFICATION), WIPRO, STOCK_EXCHANGE, NONE, NYSE}” and “{NE_MISSEDCLASSIFICATION), WIPRO, SCRIP_NAME, NONE, WIT}.” Accordingly, if the IE computing device 12 determines that there is an NE missed classification in step 308, then the Yes branch is taken to step 310.

In step 310, the IE computing device 12 optionally generates, and outputs via the interactive GUI, portions of the input data corpus including one or more of the expected result objects. In this example, the IE computing device 12 identifies and output portions or sentences of the input data corpus including the “NYSE” and “WIT” expected results objects.

In step 312, the IE computing device 12 receives, via the interactive GUI, a selection of one or more of the portions of the input data that represent an expected relationship associated with the NE missed classification determined in step 308. The interactive GUI can be provided to the one of the annotator devices 14(1)-14(n) in this example, and the selection of the portion(s) representing expected relationship(s) can be received via the interactive GUI and from the one of the annotator devices 14(1)-14(n), although other methods of providing portions of the input data corpus and receiving selections of correct data portions included therein can also be used in other examples.

In step 314, the IE computing device 12 optionally generates target relation data portion(s) or sentence(s) based on the parent relation classes and child relation classes, identified in step 308, using stored artificial data. The artificial data can include tokens or other data associated with the “STOCK_EXCHANGE” relation triplet, the “SCRIP_NAME” relation triplet, the associated parent or child class, or any other triplet or custom class in this example. Accordingly, the subject or object in the target relation data portion(s) can be replaced with the artificial data, although other modifications can also be made and other types of target relation data portion(s) can also be generated in step 314.

Illustrated below in Table 5 is an example input data corpus:

TABLE 5
Example input data corpus including unstructured text

Wipro Limited
WIT $5.96* 0.030.5%
*Delayed - data as of Aug. 25, 2017 - Find a broker to begin trading WIT
now
Exchange: NYSE
Industry: Technology
Community Rating: Bullish

The input data corpus in the example illustrated in Table 5 includes unstructured textual data relating to stock information for a corporate organization.

Illustrated below in Table 6 is the exemplary input data corpus of Table 5 after named entity classifier convergence:

TABLE 6
Example input data corpus of Table 5 after NE classifier convergence

| | | | | | | | | | | | |
|---|---|---|---|---|---|---|---|---|---|---|---|
| 0 | ORGANIZATION | | | 0 | O | NNP/NNP | | Wipro/Limited | | O | O |
| 0 | SCRIP_NAME | | | 1 | O | NNP | WIT | O | O | O | |
| 0 | MONEY | | 2 | O | $/CD | $/5.96 | O | O | O | | |
| 0 | O | 3 | O | SYM | * | O | O | O | | | |
| 0 | PERCENT | | 4 | O | CD/NN | | 0.030.5/% | | O | O | O |
| 0 | O | 5 | O | SYM | * | O | O | O | | | |
| 0 | O | 6 | O | VBN | Delayed | | O | O | O | | |
| 0 | O | 7 | O | : | — | O | O | O | | | |
| 0 | O | 8 | O | NNS | data | O | O | O | | | |
| 0 | O | 9 | O | IN | as | O | O | O | | | |
| 0 | O | 10 | O | IN | of | O | O | O | | | |
| 0 | DATE | 11 | O | NNP/CD/,/CD | Aug./25/,/2017 | | | | O | O | O |
| 0 | O | 12 | O | : | — | O | O | O | | | |
| 0 | O | 13 | O | VB | Find | O | O | O | | | |
| 0 | O | 14 | O | DT | a | O | O | O | | | |
| 0 | O | 15 | O | NN | broker | O | O | O | | | |
| 0 | O | 16 | O | TO | to | O | O | O | | | |
| 0 | O | 17 | O | VB | begin | O | O | O | | | |
| 0 | O | 18 | O | VBG | trading | O | O | O | | | |
| 0 | SCRIP_NAME | | | 19 | O | NN | WIT | O | O | O | |
| 0 | O | 20 | O | RB | now | O | O | O | | | |
| 0 | O | 21 | O | NNP | Exchange | | O | O | O | | |
| 0 | O | 22 | O | O | : | O | O | O | | | |
| 0 | STOCK_EXCHANGE | | | | 23 | O | NNP | NYSE | O | O | O |
| 0 | O | 23 | O | NNP | Industry | | O | O | O | | |
| 0 | O | 24 | O | : | : | O | O | O | | | |
| 0 | O | 25 | O | NNP | Technology | | O | O | O | | |
| 0 | O | 26 | O | NNP | Community | | O | O | O | | |
| 0 | O | 27 | O | NNP | Rating | O | O | O | | | |
| 0 | O | 28 | O | : | : | O | O | O | | | |
| 0 | O | 29 | O | JJ | Bullish | O | O | O | | | |

Convergence occurs when the classifiers of the NE classifier cluster 36 or RE classifier cluster 38 meet an acceptable accuracy score.

Illustrated below in Table 7 is the exemplary input data corpus of Table 5 modified based on an artificial sentence to improve classifier training:

TABLE 7
Example artificial sentence for the input data corpus of Table 5

| | | | | | | | | | | | |
|---|---|---|---|---|---|---|---|---|---|---|---|
| 0 | ORGANIZATION | | | 0 | O | NNP/NNP | | Microsoft/Corp. | | | O |
| 0 | SCRIP_NAME | | | 1 | O | NNP | MSFT | O | O | O | |
| 0 | MONEY | | 2 | O | $/CD | $/5.96 | O | O | O | | |
| 0 | O | 3 | O | SYM | * | O | O | O | | | |
| 0 | PERCENT | | 4 | O | CD/NN | | 0.030.5/% | | O | O | O |
| 0 | O | 5 | O | SYM | * | O | O | O | | | |
| 0 | O | 6 | O | VBN | Delayed | | O | O | O | | |
| 0 | O | 7 | O | : | — | O | O | O | | | |
| 0 | O | 8 | O | NNS | data | O | O | O | | | |
| 0 | O | 9 | O | IN | as | O | O | O | | | |
| 0 | O | 10 | O | IN | of | O | O | O | | | |
| 0 | DATE | 11 | O | NNP/CD/,/CD | Aug./25/,/2017 | | | | O | O | O |
| 0 | O | 12 | O | : | — | O | O | O | | | |
| 0 | O | 13 | O | VB | Find | O | O | O | | | |
| 0 | O | 14 | O | DT | a | O | O | O | | | |
| 0 | O | 15 | O | NN | broker | O | O | O | | | |
| 0 | O | 16 | O | TO | to | O | O | O | | | |
| 0 | O | 17 | O | VB | begin | O | O | O | | | |
| 0 | O | 18 | O | VBG | trading | O | O | O | | | |
| 0 | SCRIP_NAME | | | 19 | O | NN | MSFT | O | O | O | |
| 0 | O | 20 | O | RB | now | O | O | O | | | |
| 0 | O | 21 | O | NNP | Exchange | | O | O | O | | |
| 0 | O | 22 | O | O | : | O | O | O | | | |
| 0 | STOCK_EXCHANGE | | | | 23 | O | NNP | NYSE | O | O | O |
| 0 | O | 23 | O | NNP | Industry | | O | O | O | | |
| 0 | O | 24 | O | : | : | O | O | O | | | |
| 0 | O | 25 | O | NNP | Technology | | O | O | O | | |
| 0 | O | 26 | O | NNP | Community | | O | O | O | | |
| 0 | O | 27 | O | NNP | Rating | O | O | O | | | |
| 0 | O | 28 | O | : | : | O | O | O | | | |
| 0 | O | 29 | O | JJ | Bullish | O | O | O | | | |

In this example, the “SCRIP_NAME” has been changed based on stored artificial data associated with that relation triplet. Subsequent to generating the target relation data portions, or if the IE computing device 12 determines that an NE classification has not been missed in step 308 and the No branch is taken, then the IE computing device proceeds to step 316.

In step 316, the IE computing device 12 retunes the NE or RE classifier models, such as by retraining one or more classifiers in the NE classifier cluster 36 or the RE classifier cluster 38, based on the NE missed classification(s) identified in step 308, as well as any other misclassification or missed classification corresponding to annotation(s) received in step 304. The retuning or retraining can be performed on the machine-readable annotation language corresponding to the missed classification(s) or misclassification(s), as described and illustrated earlier with reference to the operation of the NE classifier trainer module 30 or the RE classifier trainer module 32, for example. Further, the retuning can include modifying stored training data based on the target relation data portion(s) or the received selection of the portion(s) of the input data corpus. The modified stored training data can be sent to the NE classifier trainer module 30 or the RE classifier trainer module 32 to facilitate the retuning. Additionally, the NE or RE classifier models can be retuned subsequent to one or more other of the steps illustrated in FIG. 3.

As described and illustrated herein, this technology advantageously facilitates improved NLP and IE for unseen, unstructured or semi-structured machine-readable input data corpora. In particular, this technology utilizes machine learning to retrain classifiers based on annotator feedback regarding NE and RE misclassification and RE missed classifications, as well as automatically identified NE missed classifications. By modifying training data and retuning classifier models, this technology reduces false positives and negatives, resulting in more accurate IE and improved functioning of NLP systems and devices.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for improved information extraction (IE) using adaptive learning and statistical and deterministic classifiers, the method implemented by one or more IE computing devices and comprising:
applying one or more named entity (NE) or relationship extraction (RE) classifier models to an obtained semi-structured or unstructured machine-readable input data corpus to extract and output structured data to an interactive graphical user interface (GUI);
obtaining, via the interactive GUI, an annotation of at least one RE missed classification, RE misclassification, or NE misclassification in the structured data;
automatically determining when the RE missed classification or RE misclassification resulted from the NE misclassification or an NE missed classification based on an analysis of the annotation and one or more merged relationship classes or relation triplet objects; and
retuning the NE classifier model based on the NE missed classification or NE misclassification, when the determining indicates that the RE missed classification or RE misclassification resulted from the NE misclassification or NE missed classification.

2. The method of claim 1, wherein the merged relationship classes each comprise one or more parent relation classes and one or more child relation classes, the annotation comprises one or more expected result objects for the RE missed classification, RE misclassification, or NE misclassification, and the method further comprises converting the annotation into a machine-readable annotation language.

3. The method of claim 2, further comprising:
identifying, and outputting via the GUI, one or more portions of the input data corpus including one or more of the expected result objects;
receiving, via the GUI, a selection of one or more of the portions of the input data corpus that represent an expected relationship.

4. The method of claim 2, further comprising generating one or more target relation data portions based on the parent relation classes and child relation classes using stored artificial data.

5. The method of claim 4, further comprising modifying stored training data based on one or more of the target relation data portions or the received selection of the one or more of the portions of the input data corpus.

6. The method of claim 1, further comprising tokenizing, splitting, part-of-speech tagging, lemmatizing, parsing, or applying one or more deterministic or conditional random field (CRF) statistical classifiers to the input data corpus.

7. An information extraction (IE) computing device, comprising memory comprising programmed instructions stored thereon and one or more processors coupled to the memory and configured to be capable of executing the stored programmed instructions to:
apply one or more named entity (NE) or relationship extraction (RE) classifier models to an obtained semi-structured or unstructured machine-readable input data corpus to extract and output structured data to an interactive graphical user interface (GUI);
obtain, via the interactive GUI, an annotation of at least one RE missed classification, RE misclassification, or NE misclassification in the structured data;
automatically determine when the RE missed classification or RE misclassification resulted from the NE misclassification or an NE missed classification based on an analysis of the annotation and one or more merged relationship classes or relation triplet objects; and
retune the NE classifier model based on the NE missed classification or NE misclassification, when the determining indicates that the RE missed classification or RE misclassification resulted from the NE misclassification or NE missed classification.

8. The IE computing device of claim 7, wherein the merged relationship classes each comprise one or more parent relation classes and one or more child relation classes, the annotation comprises one or more expected result objects for the RE missed classification, RE misclassification, or NE misclassification, and the one or more processors are further configured to be capable of capable of executing the stored programmed instructions to convert the annotation into a machine-readable annotation language.

9. The IE computing device computing device of claim 8, wherein the one or more processors are further configured to be capable of capable of executing the stored programmed instructions to:
identify, and out via the GUI, one or more portions of the input data corpus including one or more of the expected result objects;
receive, via the GUI, a selection of one or more of the portions of the input data corpus that represent an expected relationship.

10. The IE computing device computing device of claim 8, wherein the one or more processors are further configured to be capable of capable of executing the stored programmed instructions to generate one or more target relation data portions based on the parent relation classes and child relation classes using stored artificial data.

11. The IE computing device computing device of claim 10, wherein the one or more processors are further configured to be capable of capable of executing the stored programmed instructions to modify stored training data based on one or more of the target relation data portions or the received selection of the one or more of the portions of the input data corpus.

12. The IE computing device computing device of claim 7, wherein the one or more processors are further configured to be capable of capable of executing the stored programmed instructions to tokenize, split, part-of-speech tag, lemmatize, parse, or apply one or more deterministic or conditional random field (CRF) statistical classifiers to the input data corpus.

13. A non-transitory computer readable medium having stored thereon instructions for improved information extraction (IE) using adaptive learning and statistical and deterministic classifiers comprising executable code which when executed by one or more processors, causes the one or more processors to:
apply one or more named entity (NE) or relationship extraction (RE) classifier models to an obtained semi-structured or unstructured machine-readable input data corpus to extract and output structured data to an interactive graphical user interface (GUI);
obtain, via the interactive GUI, an annotation of at least one RE missed classification, RE misclassification, or NE misclassification in the structured data;
automatically determine when the RE missed classification or RE misclassification resulted from the NE misclassification or an NE missed classification based on an analysis of the annotation and one or more merged relationship classes or relation triplet objects; and
retune the NE classifier model based on the NE missed classification or NE misclassification, when the determining indicates that the RE missed classification or RE misclassification resulted from the NE misclassification or NE missed classification.

14. The non-transitory computer readable medium of claim 13, wherein the merged relationship classes each comprise one or more parent relation classes and one or more child relation classes, the annotation comprises one or more expected result objects for the RE missed classification, RE misclassification, or NE misclassification, and the executable code, when executed by the one or more processors, further causes the one or more processors to convert the annotation into a machine-readable annotation language.

15. The non-transitory computer readable medium of claim 14, wherein the executable code, when executed by the one or more processors, further causes the one or more processors to:
identify, and out via the GUI, one or more portions of the input data corpus including one or more of the expected result objects;
receive, via the GUI, a selection of one or more of the portions of the input data corpus that represent an expected relationship.

16. The non-transitory computer readable medium of claim 14, wherein the executable code, when executed by the one or more processors, further causes the one or more processors to generate one or more target relation data portions based on the parent relation classes and child relation classes using stored artificial data.

17. The non-transitory computer readable medium of claim 16, wherein the executable code, when executed by the one or more processors, further causes the one or more processors to modify stored training data based on one or more of the target relation data portions or the received selection of the one or more of the portions of the input data corpus.

18. The non-transitory computer readable medium of claim 13, wherein the executable code, when executed by the one or more processors, further causes the one or more processors to tokenize, split, part-of-speech tag, lemmatize, parse, or apply one or more deterministic or conditional random field (CRF) statistical classifiers to the input data corpus.
